(19) United States
(12) Patent Application Publication
(10) Pub. No.: US 2012/0173461 A1
(43) Pub. Date: Jul. 5, 2012

(54) System to promote the sale of music media

(76) Inventor: Kent P. Burk, Gilbert, AZ (US)

(21) Appl. No.: 12/930,213

(22) Filed: Dec. 30, 2010

(51) Int. Cl. G06Q 90/00; B65D 85/57

(52) U.S. Cl. 705/500; 206/308.1

(57) ABSTRACT

A system to facilitate the sale of music media correlates a music concert with the purchase of music media to provide a customer with a preferential ticket purchase for the concert.

This invention relates to music media.

In a further respect, the invention relates to the sale of music media and of tickets to concerts related to the music media.

Those of skill in the art have for many years endeavored to provide systems which promote and increase the sale of music media. Therefore, it is desirable to provide such a system.

Accordingly, it is an object of the instant invention to provide an improved system to increase the sale of music media.

A further object of the invention is to provide a system to promote concerts by music performers.

These and other, further and more specific objects and advantages will be apparent to those skilled in the art from the following detailed description thereof, taken in conjunction with the drawings, in which

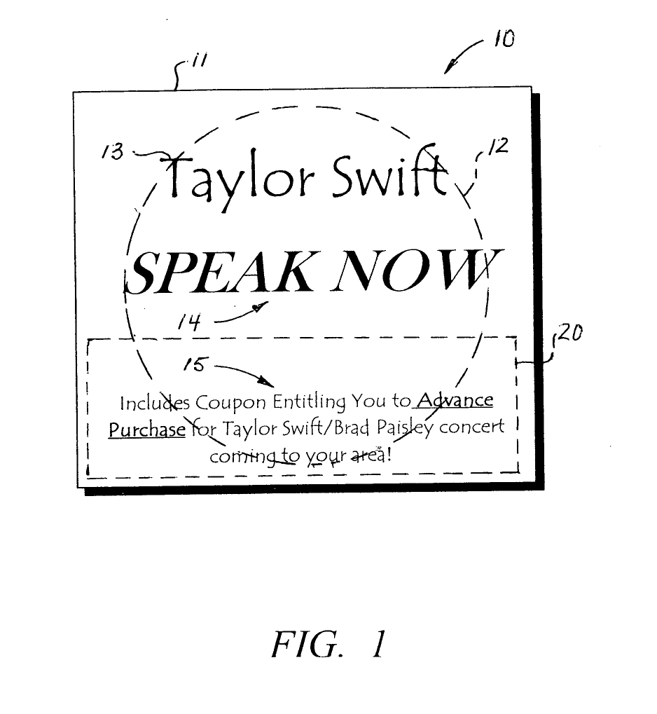

FIG. 1 is a top view illustrating a CD package constructed in accordance with one embodiment of the invention.

Briefly, in accordance with the invention, provided is an improved system to facilitate the sale of music media and provide a customer with a preferential ticket purchase for a concert relating to the music media. The system comprises the steps of preparing a recording of a musical performance; preparing an activation coupon which enables a customer to obtain a preferential ticket purchase for the concert; combining the recording and the activation coupon to produce a music media—coupon package; offering the music-media—coupon package for sale; selling the music-media—coupon package; accepting the activation coupon from the music-media—coupon package for a musical performance ticket for a concert in advance of general ticket sales for the concert, the concert relating to said recording.

In another embodiment of the invention, an improved media package is provided for retail sale to the public to facilitate the sale of music media and provide a customer with a preferential ticket purchase for a concert relating to the music media. The media package comprises a recording of a musical performance; an activation coupon which enables a customer to obtain a preferential ticket purchase for the concert, the concert relating to said recording; and, packaging for retail sale of the recording and the activation coupon. The packaging includes alpha numeric characters identifying both the recording and the activation coupon containing in the packaging.

Turning now to the drawing, which is provided by way of illustration and not limitation of the invention, FIG. 1 illustrates a CD (compact disc) package generally indicated by reference character 10 and including a CD 12 housed in a conventional, rectangular CD case 11. Printed material in or on the case 11 includes alphanumeric characters which identify the recording artist(s) 13 and the name 14 of the album. The printed material can, by way of example and not limitation, comprise an insert that is inside the case and is viewable from the exterior of the case because the case is transparent, can comprise printed on label fixedly attached to the case 11, or can comprise printed formed directly on case 11.

Alphanumeric characters are also utilized on the printed material to indicate 15 that the CD package 10 includes a preferential ticket purchase coupon 20 which enables the purchaser of the CD package 10 to purchase, beginning on a specified date, a ticket to a specific selected related music concert(s) in advance of general ticket sales to the public for that concert. The ability to purchase a concert ticket in advance of general ticket sales often also provides preferential seating because it is more likely that better seats will be available at that time than will be available after general ticket sales begin. The ability of a consumer to purchase a ticket for a selected associated concert in advance of general ticket sales to the public is critical in the practice of the invention because it provides the consumer with incentive both to purchase the CD package 10 and to attend the concert. The artist(s) that perform on the CD package 10 normally, although not necessarily, also perform at the selected associated concert. This can be advantageous to the artist who is marketing the CD package 10 because the CD 12 ordinarily, although not necessarily, contains a plurality of songs and is sold at a price in excess of the price necessary to purchase and download only a single song from a web site on the Internet. Further, CD package 10 can include coupons and other promotional materials for items which may or may not be related to the musical performance on the CD 12. For example, one coupon could offer for sale items related to the musical performance. Such an item might be cosmetics sold by Taylor Swift. Another coupon could offer for sale a cruise to the Mediterranean, which cruise is not related to Taylor Swift's musical performance—unless Taylor Swift will be present on the cruise. As noted, a CD may only include single song, further, one or more songs can also be sold on “vinyl” (i.e., a record).

The Taylor Swift/Brad Paisley concert referred to in the printed material in or on the CD package 10 is related to the musical performance on the CD 12 because at least one of the performers on the CD 12, namely Taylor Swift, is participating in the concert. If Dolly Parton sings a duet with Taylor on the CD 12, then a concert by Dolly Parton would also be related to the musical performance on the CD 12. If Dolly Parton during a concert sings a song that is sung on the CD only by Taylor Swift, then that concert would also be related to the musical performance on the CD 12. While any desired concert can be selected to correlate with the sale of CD 12 and enable a preferential ticket purchase to the concert, a concert that is selected to correlate with the sale of the CD 12 will normally be related to the CD 12 in one of the ways described above in this paragraph.

In another embodiment of the invention, a consumer purchases and downloads at least one song from the Internet onto the consumer's computer, iPhone, etc. When the consumer purchases the songs on the Internet, he is able to print coupon 20 on his printer. The coupon 20 grants, once a verification or access code has been activated by the consumer, the consumer the privilege of a preferential ticket purchase for a selected concert(s) that is associated with the song purchased from the Internet. As would be appreciated by those of skill in the art, a consumer can comprise the person that originally purchases the song and receives the access code, or can comprise a person that receives the access code or ticket as a gift. The coupon 20 can have a bar code, serial number, or other identification data which can be compared with information concerning the date of the consumer's purchase, credit card number, or any other desired information so that when the consumer appears, in advance of general ticket sales, at a ticket office to purchase a ticket to a concert, the ticket office can scan the bar code or otherwise “read” the consumer's coupon and compare the identification data with information stored on a computer concerning the on-line purchase by the consumer of the song(s). The ticket clerk can ask for a driver's license or other identification information to facilitate confirming that the consumer is the individual that purchased the song(s) and received the coupon 20.

In a further embodiment of the invention, when CD 12 or a vinyl recording of one or more songs is purchased on the Internet (from Amazon.com, for example) (or for that matter at a retail or wholesale outlet) or when at least one song is purchased on and downloaded from the Internet, the consumer does not print a coupon 20. A receipt is e-mailed to the consumer. A verification or access code is provided on the receipt. The consumer goes to another web site and enters the access code to reserve the consumer's right to purchase a ticket in advance of general ticket sales to the public. The fact that the consumer is entitled to a preferential ticket purchase is, after the consumer enters the access code to reserve the right to purchase a ticket in advance of general ticket sales, “digitally” stored in the memory of a computer. When the consumer appears at a ticket office at a prescribed date prior to the opening of general ticket sales for a concert, and provides the access code, and a driver's license or other identification, the ticket clerk accesses the computer, confirms that the consumer did purchase CD 12 and did register the access code and is entitled to the preferential purchase of a concert ticket, and sells the concert ticket to the consumer. Similarly, if the consumer elects to purchase a ticket on line, he or she goes to an appropriate web site at the prescribed time prior to the opening of general ticket sales and provides the access code. The web site permits the consumer to purchase a concert ticket. The concert ticket is mailed to the consumer. In an alternate embodiment of the invention, when a consumer appears in person at a ticket office, the consumer only need provide the access code to purchase a ticket.

In another embodiment of the invention, coupon 20, in addition to providing a consumer with the important privilege of a preferential ticket purchase which enables the consumer to purchase a ticket for a particular selected related concert in advance of the opening of general ticket sales to the public, pays for all or a portion of a concert ticket that is purchased by the consumer.

In still a further embodiment of the invention, when a consumer purchases a CD 10, the coupon 20 consists of an activation card which includes an activation code. The consumer logs onto the web site of the record label or performer, inputs his or her name and email address, and clicks on a link—for instance a “Concert Series” link. At the “Concert Series” link, the consumer inputs the activation code from the card. This activates the activation card and enables the consumer to take the activation card to a Ticketmaster outlet or other ticket outlet that sells concert tickets for the particular concert that is related to CD 10. The consumer can purchase, beginning on a selected date, a ticket at the ticket outlet prior to the date that general admission tickets are sold to the public.

In still another Internet embodiment of the invention, after a consumer purchases online from a record label/performer web site the one or more songs, the consumer is issued an access code which he or she can write down or print on the consumer's printer. The consumer clicks (at the record label/performer web site) on a link—for instance a “Concert Series” link. At the “Concert Series” link, the consumer inputs his or her name, email address, and the access code. The consumer prints out an activation card. The consumer to take the activation card to a Ticketmaster outlet or other ticket outlet that sells concert tickets for the particular concert that is related to CD 10. The consumer can then, beginning on a specified date (which typically could be a Wednesday), purchase a ticket at the ticket outlet prior to the date (typically the first Saturday after said Wednesday) that general admission tickets are sold to the public.

In yet another embodiment of the invention, the concert includes an opening act along with the individual(s) or group(s) that perform the music on CD 12. The revenues from the concert are shared between the opening act and performer(s) on CD 12 in any desired manner, but can be split by comparing the album sales of the opening act and performer(s) in the city where the concert takes place. For example, if the album sales of the opening group are equal to those of the performer(s) on CD 12, then the concert revenues are split equally between the opening act and the performer(s) on CD 12.

In still yet another embodiment of the invention the quality of the privilege obtained by a consumer increases as the quantity of the consumer's purchase increases. For example, if the consumer buys a single song, he may be permitted to purchase a ticket only one day prior to the beginning of general ticket sales. If, on the other hand, the consumer buys a CD which has twelve songs, the consumer may be permitted to purchase a ticket four days prior to the beginning of general ticket sales, and may also have the privilege of purchasing a ticket on-line in advance of general tickets sales and having the ticket sent to him via the post or via e-mail. If a consumer purchases a ticket on line, it is preferred that the consumer provide or verify an access code. The access code is provided the consumer when he purchases a CD, purchases a song(s) on line, or purchases some other music media.

Beginning in the 1990s, popular use of the Internet began to significantly damage the business of marketing music in albums recorded on records (“vinyl”), tapes, CDs, and DVDs. Once the music of an artist is released, it is converted to an MP3 or MP4 format and copied over and over again without the consent of the artist, or the artist's recording label. Millions of consumers share the artist's music without paying a royalty to the artist that created the music. As a result, many recording companies are no longer in business. The invention helps to offset lost revenue by providing an incentive and methodology for consumers to purchase albums at retail or wholesale outlets or to purchase one or more songs or performances on the Internet. The invention, practically speaking, requires the individual(s) or group(s) performing the music on a CD 12 to tour and participate in live performances, or, to at least participate in at least one live performance. Consequently, performers that do not participate in live tour performances are less likely to benefit from the invention; however, songs that appear on a CD (or are downloaded from the Internet) of a first performer can be tied to a concert in which a second performer provides a rendition of the first performer's song. A consumer purchasing the first performer's CD is given preferential ticket purchase to a concert by the second performer. In this fashion, both the first performer and the second performer benefit from the first performer's CD. As used herein, the term CD indicates a physical disc that a consumer purchases at a retail or wholesale outlet. The retail or wholesale outlet can comprise a store like Best Buy which has a physical location into which a consumer walks to purchase and take possession of a CD, or can comprise an online store like Amazon.com.

As utilized herein, music media comprises recordings of music performances including, without limitation, records (also known as “vinyl”), tapes, CDs, DVDs, movies, and recordings found on the Internet. The music media comprises recordings of at least one song or musical composition.

Having described my invention in such terms as to enable those skilled in the art to understand and practice it, and having described the best mode thereof, I Claim:

1. A system to facilitate the sale of music media and provide a customer with preferential seating at a concert relating to said music media, comprising the steps of
(a) preparing a recording of a musical performance;
(b) preparing an activation coupon which enables a customer to obtain a preferential ticket purchase for the concert,
(c) combining said recording and said activation coupon to produce a music media—coupon package;
(d) offering said music-media—coupon package for sale;
(e) selling said music-media--coupon package;
(f) accepting said activation coupon from said music-media--coupon package for purchasing a musical performance ticket for a concert in advance of general ticket sales for said concert, said concert relating to said recording.

2. A media package for retail sale to the public to facilitate the sale of music media and provide a customer with a preferential ticket purchase for a concert relating to said music media, comprising
(a) a recording of a musical performance;
(b) an activation coupon which enables a customer to obtain a preferential ticket purchase for a concert, said concert relating to said recording; and,
(c) packaging for retail sale of said recording and said activation coupon, said packaging including alpha numeric characters identifying both the recording and the activation coupon containing in said packaging.
